(19) United States
(12) Patent Application Publication
(10) Pub. No.: US 2011/0274309 A1
(43) Pub. Date: Nov. 10, 2011

(54) MICRO SPEAKER

(75) Inventors: Sung-Hwan Doh, Gyeonggi-do (KR); Han-Ryang Lee, Gyeonggi-do (KR); Sang-Ho Lee, Incheon (KR)

(73) Assignee: BSE CO., LTD., Incheon (KR)

(21) Appl. No.: 13/144,756

(22) PCT Filed: Aug. 31, 2009
(86) PCT No.: PCT/KR09/04875

§ 371 Date: Jul. 15, 2011

(30) Foreign Application Priority Data
Mar. 11, 2009 (KR) 10-2009-0020723

(51) Int. Cl. H04R 1/00

(52) U.S. Cl. 381/398

(57) ABSTRACT

A micro speaker including a frame; a yoke fixed to the frame and including a receiving groove; a permanent magnet spaced apart from an inner lateral wall of the receiving groove of the yoke, and fixed to a bottom surface of the yoke; a plate fixed to an upper surface of the permanent magnet, spaced apart from the inner lateral wall of the receiving groove of the yoke, and fixed to the yoke; a diaphragm having an outer circumferential portion fixed to the frame; a base film fixed to a lower surface of the diaphragm and including a first coil that has a planar shape and is printed to have a coil pattern; and a second coil that is formed by winding a wire, has an upper end portion fixed to a lower surface of the base film, extends downwards from the upper end portion, and is electrically connected to the first coil.

### TECHNICAL FIELD

One or more aspects of the present invention relate to a micro speaker, and more particularly, to a micro speaker including a planar coil in addition to a conventional voice coil, thereby adjusting and improving an acoustic feature.

### BACKGROUND ART

A speaker is a device for converting an electrical signal into a voice signal. Speakers may be classified into middle and large-sized speakers and small-sized speakers. A middle and large-sized speaker is connected to a stereo or amplifier so as to amplify a sound. A small-sized speaker is used in small-sized portable devices, such as cellular phones, notebook computers, MP3 players, earphones, and the like. Demands for such devices have risen sharply recently. Generally, the small-sized speaker is referred to as a micro speaker.

A conventional micro speaker 100 will now be briefly described. FIG. 1 is a cross perspective view of a portion of the conventional micro speaker 100.

The conventional micro speaker 100 includes a frame 101, a yoke 102, a permanent magnet 103, a plate 104, a voice coil 105, and a diaphragm 106. Although not illustrated in FIG. 1, in general, a cover is attached to an upper portion of the frame 101.

The frame 101 forms an outer appearance of the conventional micro speaker 100. A vent (not shown) is formed through one side of the frame 101. The permanent magnet 103, the plate 104, and the yoke 102 constitute a magnetic circuit. The diaphragm 106 is divided into an inner portion 107 and an outer portion 109, with respect to a boundary portion 108. An upper end portion of the voice coil 105 formed by winding a wire is adhered to a lower surface of the boundary portion 108 of the diaphragm 106. A non-wound portion (not shown) of the voice coil 105 is exposed out of the frame 101 so as to be connected to an external power source.

A lower portion of the voice coil 105 is disposed in a magnetic gap formed between inner lateral walls of the plate 104 and the yoke 102. When a current signal of which frequency varies is supplied to the voice coil 105, mechanical energy is generated from the voice coil 105 due to interaction between the current signal and a magnetic field according to a current intensity and a frequency size, and thus, the voice coil 105 moves up and down. Then, the diaphragm 106, to which the voice coil 105 is fixed, also moves up and down to generate a vibration, thereby generating a sound pressure having a predetermined amplitude audible to human ears.

However, since the conventional micro speaker 100 uses only a single voice coil 105 coupled to the diaphragm 106 and the voice coil 105 is placed in the magnetic gap having a limited size, there is a limit in determining a range of available wires and it is difficult to control the Q value of a dynamical system by using a single voice coil only.

In addition, since a single voice coil is used, it is difficult to control a rocking mode in which a non-vertical vibration instead of a vertical vibration occurs. In addition, a portion of a magnetic flux generated by the plate 104, which enters the yoke 102 rather than being transmitted through the voice coil 105, is not used.

### DISCLOSURE OF THE INVENTION

### Technical Problem

One or more aspects of the present invention provide a micro speaker including a voice coil that has a planar shape and a printed coil pattern, in addition to a conventional voice coil, thereby being possible to control the impedance characteristics of the micro speaker if necessary.

### Technical Solution

According to an aspect of the present invention, there is provided a micro speaker including a frame; a yoke fixed to the frame and including a receiving groove; a permanent magnet spaced apart from an inner lateral wall of the receiving groove of the yoke, and fixed to a bottom surface of the yoke; a plate fixed to an upper surface of the permanent magnet, spaced apart from the inner lateral wall of the receiving groove of the yoke, and fixed to the yoke; a diaphragm having an outer circumferential portion fixed to the frame; a base film fixed to a lower surface of the diaphragm and including a first coil that has a planar shape and is printed to have a coil pattern; and a second coil that is formed by winding a wire, has an upper end portion fixed to a lower surface of the base film, extends downwards from the upper end portion, and is electrically connected to the first coil.

The first coil and the second coil may be connected in parallel to each other. The first coil and the second coil may be connected in series to each other.

The base film may be a flexible board, the first coil may be printed on the flexible board, and a combination of the base film and the first coil may constitute a flexible printed circuit (FPCB).

The first coil may be disposed on at least one of an upper surface of the base film and the lower surface of the base film.

The diaphragm may be divided into an inner portion and an outer portion, with respect to a boundary portion to which the upper end portion of the second coil is coupled, and the based film may have an outer circumferential portion fixed to the frame, and a central portion adhered to the boundary portion of the diaphragm.

The base film may further include an electrical connection portion that extends outwards from an outer circumferential portion of the base film so as to be exposed out of one side of the frame.

The diaphragm may be divided into an inner portion and an outer portion, with respect to a boundary portion to which the upper end portion of the second coil is coupled, and the base film may be adhered to the boundary portion of the diaphragm, and may be spaced apart from an inner lateral wall of the frame.

### Advantageous Effects

According to one or more embodiments of the present invention, the impedance characteristics of a micro speaker may be improved.

In addition, compensation of a magnetic force or damping characteristics may be obtained by adjusting a direction of a planar coil.

Moreover, when an outer circumferential portion of a base film on which a planar coil is printed is fixed to a frame, damping characteristics of a diaphragm is improved, thereby improving vibration characteristics.

### BRIEF DESCRIPTION OF THE DRAWINGS

FIG. 1 is a cross perspective view of a portion of the conventional micro speaker;

FIG. 2 is a schematic exploded perspective view of a micro speaker according to an embodiment of the present invention;

FIG. 3 is a bottom perspective view for illustrating a state in which a diaphragm, a base film, and a second coil of FIG. 2 are coupled to each other;

FIG. 4 is an exploded perspective view of the state illustrated in FIG. 3;

FIG. 5 is a schematic cross-sectional view for illustrating a state in which the micro speaker of FIG. 2 is assembled;

FIGS. 6 and 7 are graphs of impedances when a first coil and a second coil are connected in series or in parallel to each other in the micro speaker 1, respectively, according to embodiments of the present invention;

FIG. 8 is a schematic cross-sectional view of a micro speaker according to another embodiment of the present invention; and

FIG. 9 is a plan view of a base film including a first coil, according to another embodiment of the present invention.

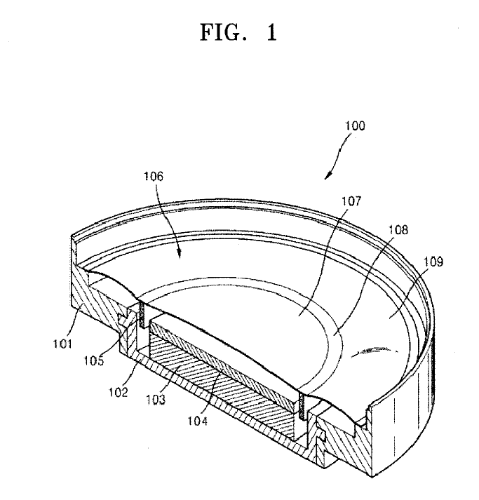

### BEST MODE FOR CARRYING OUT THE INVENTION

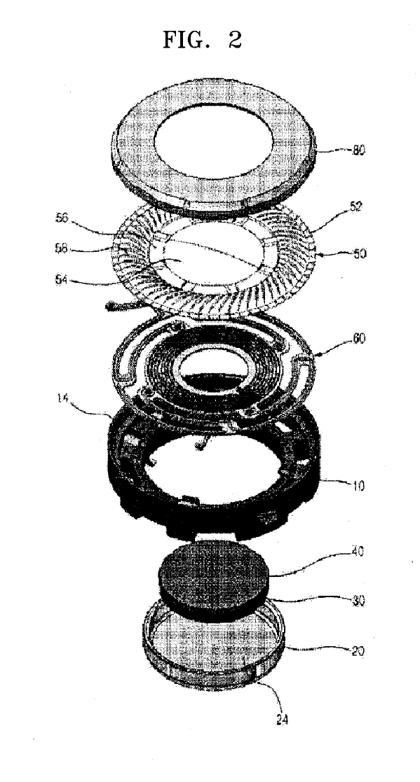

A micro speaker according to an embodiment of the present invention will be described in detail with reference to FIGS. 2 through 7.

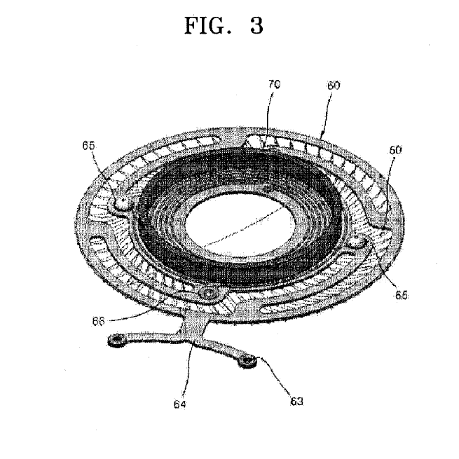

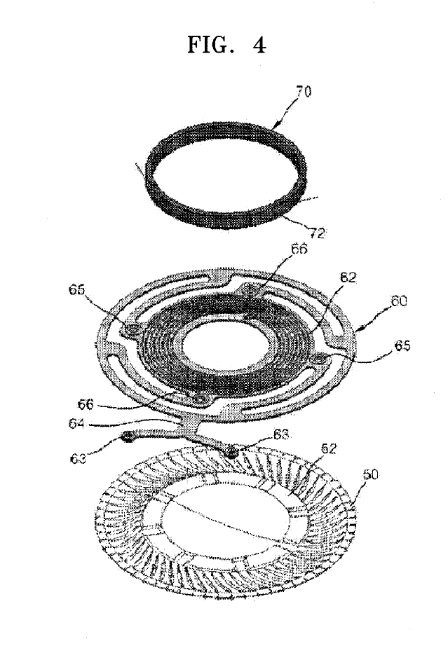

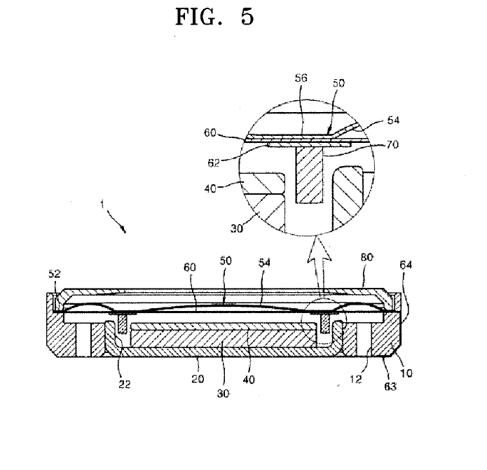

FIG. 2 is a schematic exploded perspective view of a micro speaker 1 according to an embodiment of the present invention. FIG. 3 is a bottom perspective view for illustrating a state in which a diaphragm 50, a base film 60, and a second coil 70 of FIG. 2 are coupled to each other. FIG. 4 is an exploded perspective view of the state illustrated in FIG. 3. FIG. 5 is a schematic cross-sectional view for illustrating a state in which the micro speaker 1 of FIG. 2 is assembled.

The micro speaker 1 includes a frame 10, a yoke 20, a permanent magnet 30, a plate 40, the diaphragm 50, the base film 60, and the second coil 70.

The micro speaker 1 is used in small-sized audio devices such as cellular phones, earphones, MP3 players, and the like, and is mainly characterized by including a planar coil printed on the base film 60.

The frame 10 is generally formed of plastic and forms an outer appearance of the micro speaker 1. Various components are fixed to an inner part of the frame 10. A plurality of vents 12 are formed through an outer circumferential portion of the frame 10. The vents 12 are used to discharge outwards a generated sound.

A holding surface 14 is formed on an upper end portion of the outer circumferential portion of the frame 10. An outer circumferential portion that is an edge of the base film 60 is coupled to the holding surface 14. According to the present embodiment, a cover 80 for protecting internal components is coupled to the holding surface 14.

The yoke 20 is formed of a magnetic material and is fixed to the frame 10. A concave receiving groove is formed in an inner surface of the yoke 20.

The permanent magnet 30 is formed to have a disk shape so as to correspond to the concave receiving groove of the yoke 20. The permanent magnet 30 is fixed to an inner bottom surface 24 of the yoke 20. The plate 40 having almost the same diameter as the permanent magnet 30 is fixed to an upper surface of the permanent magnet 30. The plate 40 is formed of a magnetic material.

Referring to FIG. 5, the permanent magnet 30 and the plate 40 are spaced apart from an inner lateral wall 22 of the yoke 20 and are fixed to the yoke 20. A space is formed between the inner lateral wall 22 of the yoke 20 and external lateral surfaces of the permanent magnet 30 and the plate 40. The second coil 70 described below is disposed in the space and moves up and down together with the diaphragm 50.

The permanent magnet 30, the plate 40, and the yoke 20 constitute a magnetic circuit. That is, a magnetic flux generated by the permanent magnet 30 forms a magnetic flux path that is transmitted to the yoke 20 through the plate 40.

An outer circumferential portion 52 of the diaphragm 50 is fixed to the holding surface 14 of the frame 10. In detail, an outer circumferential portion of the base film 60 described below, and the outer circumferential portion 52 of the diaphragm 50 are sequentially fixed to the holding surface 14 of the frame 10. An outer circumferential portion of the cover 80 is fixed onto the outer circumferential portion 52 of the diaphragm 50. The base film 60, the diaphragm 50, and the cover 80 are adhered to each other by adhesives.

The diaphragm 50 moves up and down according to a motion of the second coil 70 described above, and generates a sound pressure audible to human ears. The diaphragm 50 is generally formed of a high-molecular weight compound. The diaphragm 50 is manufactured by adhering or depositing different materials onto each other or depositing. The diaphragm 50 may be changed in various ways in terms of material and shape.

According to the present embodiment, the diaphragm 50 is divided into an inner portion 54 and an outer portion 58, with respect to a boundary portion 56 to which an upper end portion of the second coil 70 is fixed. Each of the inner portion 54 and the outer portion 58 has a dome shape. The boundary portion 56 is flat. The outer portion 58 is also referred to as an edge. According to the present embodiment, in consideration of an acoustic feature, the outer portion 58 includes a plurality of comb-shaped grooves formed in a circumferential direction thereof. The diaphragm 50 used in the micro speaker 1 may be changed in various ways in terms of shape, material and thickness.

The base film 60 is fixed to a lower surface of the diaphragm 50. The base film 60 includes a first coil 62 that has a planar shape and is printed to have a coil pattern.

According to the present embodiment, the base film 60 is a flexible semi-transparent board. In addition, the outer circumferential portion of the base film 60 is fixed to the holding surface 14 of the frame 10. A central portion of the base film 60 is fixed to a lower portion of the boundary portion 56 of the diaphragm 50.

According to the present embodiment, the base film 60 includes an electrical connection portion 64 that extends outwards from the outer circumferential portion of the base film 60 so as to be exposed out of one side of the frame 10. A leader line connected to the first coil 62 is printed on the electrical connection portion 64.

Referring to FIG. 5, the electrical connection portion 64 extends to a lower lateral surface of the frame 10 along an external lateral wall of the frame 10 and is fixed to the frame 10. A contact point 63 is disposed on an end portion of the electrical connection portion 64 in order to connect the electrical connection portion 64 to an external component. Since the electrical connection portion 64 is stably fixed to the frame 10, even if the diaphragm 50 vibrates, the electrical connection portion 64 barely moves downwards.

According to another embodiment of the present invention, although not illustrated, the electrical connection portion 64 may be configured in another way. That is, a first conductive portion for electrically connecting the electrical connection portion 64 to an external component may be disposed on an outer circumferential portion of a base film, and a second conductive portion may be disposed on a portion of a frame, which corresponds to the base film. The second conductive portion of the frame is electrically connected to a terminal that is disposed on an external portion of one side of the frame in order to connect to the electrical connection portion 64 to an external component. Accordingly, by simply fixing the base film to the frame, the first conductive portion of the base film and the second conductive portion of the frame, corresponding to the base film, are electrically connected to each other.

The first coil 62 is printed to have a planar shape on a lower surface of the base film 60. The first coil 62 is disposed in order to supplement the second coil 70 described below. The first coil 62 may be changed in various ways to have a desired thickness and length, in consideration of a required resistance value, and may be printed on the base film 60. According to the present embodiment, the first coil 62 is printed to have a shape with curlicues on a planar base film, similar to the second coil 70 that is wound to have a shape with a concentric circle.

With regard to the first coil 62, although electricity flows through the first coil 62 to generate heat, since wires constituting the first coil 62 are printed and are spaced apart from each other, heat may be easily dissipated rather than being concentrated, and thus, the first coil 62 is barely cut off due to heat.

According to the present embodiment, the first coil 62 is disposed on the lower surface of the base film 60 only. Alternatively, a coil may be printed and disposed on an upper surface of the base film 60 only, or coils may be printed on both two surfaces of the base film 60. When the coils are printed on both two surfaces of the base film 60, the coils may be connected in series or parallel to each other, if necessary.

According to the present embodiment, as described above, the base film 60 is a flexible board, and the first coil 62 is printed on the flexible board. Thus, a combination of the base film 60 and the first coil 62 constitutes a flexible printed circuit board (FPCB).

In addition, the base film 60 has a predetermined elasticity, and the outer circumferential portion of the base film 60 is coupled to the frame 10, the base film 60 may also function as a suspension of the diaphragm 50 including the boundary portion 56 that is fixed to the base film 60.

However, the base film 60 may be changed in various ways in terms of material and shape. That is, in terms of material, the base film 60 may be a flexible board as long as the first coil 62 may be printed on the base film 60, like according to the present embodiment, or alternatively, may be a metal film including an insulating layer. In terms of shape, the base film may have a circular shape with a similar size to the diaphragm 50, or alternatively, may have a shape corresponding to the size of the first coil 62.

The material and shape of the base film 60 may be appropriately selected in consideration of whether to control the vibration characteristics of the diaphragm 50, the length of the first coil 62, whether to include an electrical connection portion including a leader line of the first coil 62, and the like.

The second coil 70 is formed by winding a wire in an upward direction. An upper end portion 72 of the second coil 70 is adhered and fixed to the lower surface of the base film 60. The second coil 70 extends downwards from the upper end portion 72.

The second coil 70 is electrically connected to the first coil 62 that is disposed to have a planar shape on the base film 60. The second coil 70 may be connected in parallel to the first coil 62, or alternatively, may be connected in series to the first coil 62. The desired performance of the micro speaker 1 may be obtained by determining whether the first coil 62 and the second coil 70 are connected in parallel or in series to each other, and a resistance ratio between the first coil 62 and the second coil 70.

The second coil 70 corresponds to a conventional voice coil. That is, the second coil 70 is disposed in a space between the plate 40 and the inner lateral wall 22 of the yoke 20. In addition, when a current flows through the second coil 70, the second coil 70 moves up and down due to interaction between the current and a magnetic field formed by the permanent magnet 30. Thus, the diaphragm 50 vibrates. In this case, the diaphragm 50 is coupled to the second coil 70, and the base film 60 is disposed between the diaphragm 50 and the second coil 70. A positional relationship between the diaphragm 50, the base film 60, and the second coil 70 is shown in FIGS. 3 and 4.

Hereinafter, the operation and effect of the micro speaker 1 will be described.

According to the present embodiment, the micro speaker 1 further includes the first coil 62 that that is disposed to have a planar shape on the base film 60 in addition to the second coil 70 corresponding to a conventional voice coil, thereby overcoming a limitation of the second coil 70, supplementing an insufficient resistance, and adjusting the impedance characteristics.

Since the first coil 62 may be printed on the base film 60, the first coil 62 may be changed in various ways in terms of shape and type. In addition, the first coil 62 and the second coil 70 may be connected in parallel or in series to each other, and thus, the performance of the micro speaker 1 may be adjusted. In addition, by controlling a direction in which a current flows through the first coil 62, compensation of a magnetic force or damping characteristics may be obtained.

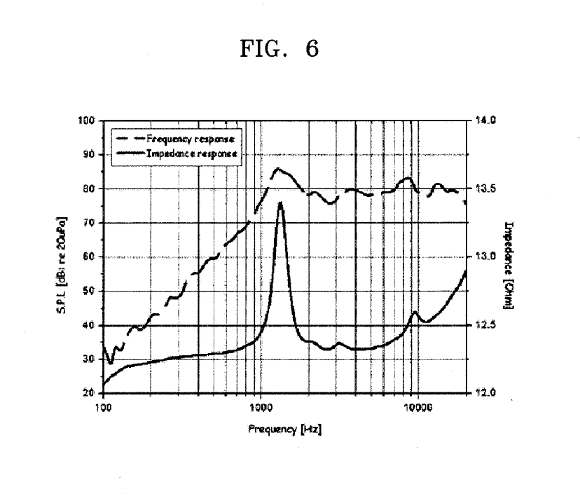

FIG. 6 is a graph of impedances when the first coil 62 and the second coil 70 are connected in series to each other in the micro speaker 1, according to an embodiment of the present invention. Referring to FIG. 6, due to two coils and suspensions, a higher-order resonance frequency band and Q value may be adjusted. In addition, by adjusting an inductance value of the second coil 70, the characteristics of the first coil 62 may be adjusted.

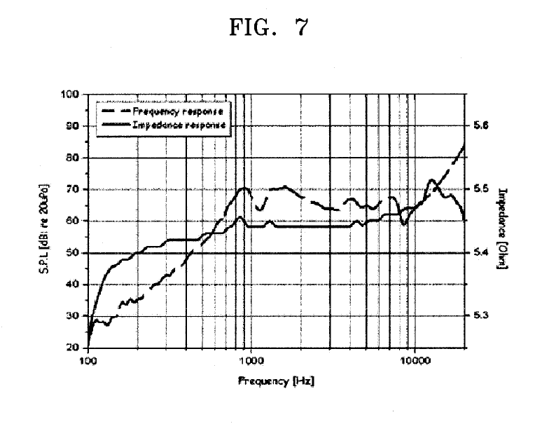

FIG. 7 is a graph of impedances when the first coil 62 and the second coil 70 are connected in parallel to each other in the micro speaker 1, according to another embodiment of the present invention. Referring to FIG. 7, flat impedance characteristics may be obtained, and speaker sensitivity and band-pass characteristics may be adjusted.

However, the graphs of FIGS. 6 and 7 are just examples. Thus, by changing the ratio and connection method of the first coil 62 and the second coil 70 in various ways, a graph with a desired shape may be obtained so as to achieve a desired acoustic feature.

Since the outer circumferential portion of the base film 60 is fixed to the frame 10, the base film 60 may also function as a suspension of the diaphragm 50. In addition, due to the electrical connection portion 64, a leader line of a convention voice coil is not required, and thus, coils may be barely cut down, and the micro speaker 1 may be easily assembled.

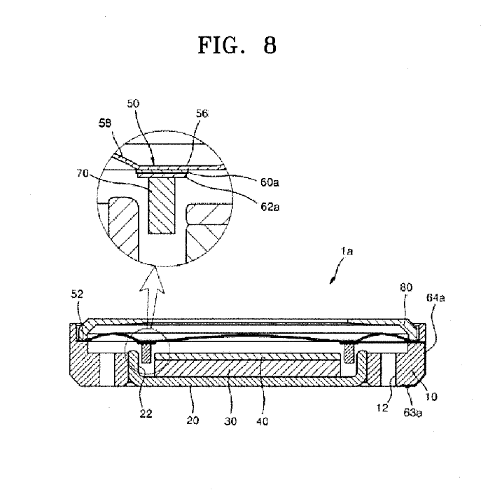

FIG. 8 is a schematic cross-sectional view of a micro speaker 1a according to another embodiment of the present invention.

According to the present embodiment, the micro speaker 1a is different from the micro speaker 1 of FIGS. 2 through 5 in that a base film 60a is spaced apart from the frame 10, but the outer circumferential portion of the base film 60 is fixed to the holding surface 14 of the frame 10 in the micro speaker 1 of FIG. 2.

According to the present embodiment, the base film 60a is adhered and fixed to a lower surface of the boundary portion 56 of the diaphragm 50. A first coil 62a is disposed on a lower surface of the base film 60a.

An electrical connection portion 64a extends from an outer circumferential portion of the base film 60a to a lower lateral surface of the frame 10 along an external lateral wall of the frame 10 and is fixed to the frame 10. In FIG. 5, the electricity connection portion 64 extends from the outer circumferential portion of the base film 60. On the other hand, according to the present embodiment, the electrical connection portion 64a extends from a portion of the outer circumferential portion of the base film 60a that is coupled to a lower surface of the boundary portion 56 of the diaphragm 50, and is exposed out of the frame 10 in order to be electrically connected to an external component. A contact point 63a is disposed on an end portion of the electrical connection portion 64a in order to easily connect the electricity connection portion 64a to an external component.

According to the above-described embodiments of the present invention, each of the micro speakers 1 and 1a has an overall cylindrical shape, and internal components have overall circular shapes. Alternatively, a shape of the micro speakers 1 and la may be changed in various ways, for example, an oval shape, a rectangular shape, or a track shape.

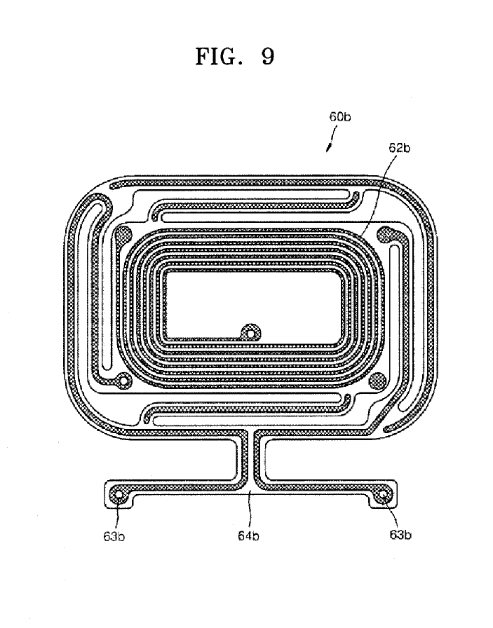

FIG. 9 is a plan view of a base film 60b having an overall rectangular shape, according to another embodiment of the present invention. The base film 60b includes a first coil 62b, a terminal 63b, and an electrical connection portion 64b. When a micro speaker includes the base film 60b, other components may have appropriate shapes corresponding to the shape of the base film 60b.

1. A micro speaker comprising:
a frame;
a yoke fixed to the frame and comprising a receiving groove;
a permanent magnet spaced apart from an inner lateral wall of the receiving groove of the yoke, and fixed to a bottom surface of the yoke;
a plate fixed to an upper surface of the permanent magnet, spaced apart from the inner lateral wall of the receiving groove of the yoke, and fixed to the yoke;
a diaphragm having an outer circumferential portion fixed to the frame;
a base film fixed to a lower surface of the diaphragm and comprising a first coil that has a planar shape and is printed to have a coil pattern; and
a second coil that is formed by winding a wire, has an upper end portion fixed to a lower surface of the base film, extends downwards from the upper end portion, and is electrically connected to the first coil.

2. The micro speaker of claim 1, wherein the first coil and the second coil are connected in parallel to each other.

3. The micro speaker of claim 1, wherein the first coil and the second coil are connected in series to each other.

4. The micro speaker of claim 1, wherein the base film is a flexible board,
wherein the first coil is printed on the flexible board, and
wherein a combination of the base film and the first coil constitutes a flexible printed circuit (FPCB).

5. The micro speaker of claim 1, wherein the first coil is disposed on at least one of an upper surface of the base film and the lower surface of the base film.

6. The micro speaker of claim 1, wherein the diaphragm is divided into an inner portion and an outer portion, with respect to a boundary portion to which the upper end portion of the second coil is coupled, and
wherein the based film has an outer circumferential portion fixed to the frame, and a central portion adhered to the boundary portion of the diaphragm.

7. The micro speaker of claim 6, wherein the base film further comprises an electrical connection portion that extends outwards from an outer circumferential portion of the base film so as to be exposed out of one side of the frame.

8. The micro speaker of claim 1, wherein the diaphragm is divided into an inner portion and an outer portion, with respect to a boundary portion to which the upper end portion of the second coil is coupled, and
wherein the base film is adhered to the boundary portion of the diaphragm, and is spaced apart from an inner lateral wall of the frame.

9. The micro speaker of claim 8, wherein the base film further comprises an electrical connection portion that extends from an outer circumferential portion of the base film so as to be exposed out of one side of the frame.
